(19) United States
(12) Patent Application Publication
(10) Pub. No.: US 2006/0005440 A1
(43) Pub. Date: Jan. 12, 2006

(54) Bicycle advertising and garphic display medium

(76) Inventors: Scott James Young, Denver, CO (US); Mark Eugene Young, New York, NY (US); Todd Harrison Hutcheson, New York, NY (US)

Correspondence Address: Scott Young, 3300 Osage Street, Denver, CO, 80211, US

(21) Appl. No.: 11/066,023

(22) Filed: Feb. 25, 2005

Related U.S. Application Data
(60) Provisional application No. 60/547,468, filed on Feb. 25, 2004.
(60) Provisional application No. 60/547,469, filed on Feb. 25, 2004.
(60) Provisional application No. 60/547,472, filed on Feb. 25, 2004.
(60) Provisional application No. 60/547,467, filed on Feb. 25, 2004.

(51) Int. Cl. G09F 21/04

(52) U.S. Cl. 40/590

(57) ABSTRACT

The present invention discloses a bicycle as an advertising and graphic display medium encompassing the frame and wheel disks as a whole. The bicycle and non-rotating wheel displays, front and back, traverse the landscape as one unit and while in a motionless state. The bicycle becomes a solid unit, frame and non-rotating display wheels become one surface.

### CROSS REFERENCE TO RELATED APPLICATIONS

Reference to:
U.S. Provisional Patent Application 60/547,468
U.S. Provisional Patent Application 60/547,469
U.S. Provisional Patent Application 60/547,472
U.S. Provisional Patent Application 60/547,467

### STATEMENT OF FEDERALLY SPONSORED RESEARCH/DEVELOPMENT

“Not Applicable”

### SEQUENCE LISTING

“Not Applicable”

### BACKGROUND OF INVENTION

The present invention describes a bicycle as an advertising and graphic display medium encompassing the frame and wheel disks, desclosed in a parallel application, as surface area for display. The bicycle and wheel disks combined result in a new and unique advertising and graphic display medium. The frame color and graphic labeling are utilized as a branding, advertising and artistic component both commercial and non commerciall. Along with the framework, the bicycle also embodies non-rotating wheel display disks attached within the rim area of the front and back wheels, imprinted with various types of indicia. Sizes and styles of bicycles, including frames, wheels and wheel display disks can be used, keeping with the overall intent of this discloser.

Bicycles are a popular mode of transportation and recreation. As their main means of use is out of doors this creates a vast commercial opportunity as an advertising display medium.

Wheel covers on bicycles have been used for aerodynamics, safety and aesthetic purposes. The problem arriving with this type of display is that it is not readable while the bicycle is in motion imprinted with a message.

Additionally, the display is inevitably not upright after the bicycle has been parked. This problem is solved within the discloser of the parallel applications sited.

Importantly, U.S. Pat. No. 4,729,604 (Dietz) discloses a “wheel shroud” designed as a single plastic cover with means to access the air valve of a bicycle wheel which rotates with the wheel.

U.S. Pat. No. 4,418,962 (Schaffer) describes a ridged spoked wheel cover, much like the above described patent, primarily for decorative purposes.

Disclosed within U.S. Pat. No. 6,568,110 (Lee, et al.) is described various uses for a non rotating display using a counterweight and a friction prevention unit including, but not limited to, a vehicle.

U.S. Pat. No. 6,122,850 (Strzeletz) describes a motorized truck as a moving billboard.

As well as U.S. Pat. No. 5,657,566 disclosing a rapid mount advertising panel which can be attached to a motorized vehicle.

The U.S. Pat. No. 5,692,331 utilizes an attached illuminated sign on a motorized vehicle as an advertising component.

It is therefore established that a vehicle for advertising when paired with four non-rotating wheel attachments is a new and unique advertising and artistic medium .

### SUMMARY OF INVENTION

The present invention relates generally to a bicycle, it's frame and a set of bicycle wheel covers, and more importantly a fully branded moving billboard with non-rotating wheel covers and a uniquely design frame.

Display disks and bicycle frame are printed as to display advertising or graphic images on their entire exterior surface of frame and extremities. Bicycles range in style as pertaining to their accompanying demographic.

### DESCRIPTION of DRAWINGS

FIG. 1. is a front view of a bicycle as a billboard utilizing wheel covers.

### DETAILED DESCRIPTION OF THE INVENTION

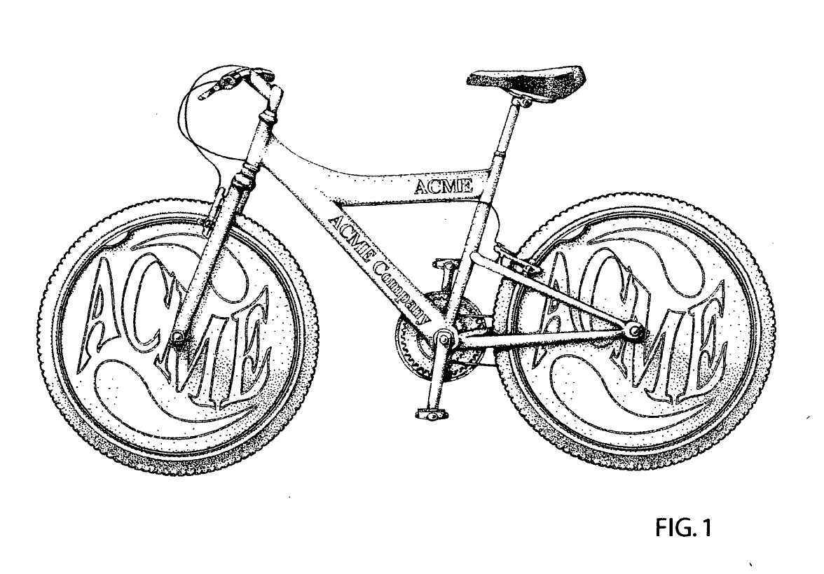

Referring now to the drawings, the preferred embodiment of the invention is shown in FIG. 1. As shown the entire bicycle becomes a billboard, whether moving or stationary.

The frame of the bicycle is encompassed with the wheels and their unique motionless appearance discovering an integral part of the entire billboard. As a whole, the billboard becomes an advertising and graphic display medium.

1. an advertising and graphic display medium encompassing the frame of a bicycle and the attached non-rotating, four wheel disks there of:
A bicycle attached to a pair of lightweight non-rotating display wheel covers that remain absolutely upright in relation to the rotation of the bicycle wheel and in relation to a parked bicycle. The invision precludes where in the wheel display medium is directly attached to a bicycle frame at the front and rear so as to create a vertical surface to apply graphics, becoming a part of the bicycle frame and it's extremities visually.
